(19) United States
(12) Patent Application Publication
(10) Pub. No.: US 2003/0035538 A1
(43) Pub. Date: Feb. 20, 2003

(54) Portable communicator with retractable earpiece and mouthpiece

(76) Inventor: Reza Jalili, Bronxville, NY (US)

Correspondence Address: Reza Jalili, 1 Vincent Rd. #3-0, Bronxville, NY, 10708, US

(21) Appl. No.: 09/932,674

(22) Filed: Aug. 17, 2001

(51) Int. Cl. H04M 1/00

(52) U.S. Cl. 379/433.01

(57) ABSTRACT

As mobile phones have gotten smaller the speaker and microphone do not reach the ear and mouth on the average person's head. The present invention is a stylish and useful way to extend the reach of the microphone and speaker to the mouth and ear. Thin flexible rods extend out of the main body of the phone. The extensions can be retracted into the body of the phone. Push-button activation and automatic extension based on ring-detection are disclosed.

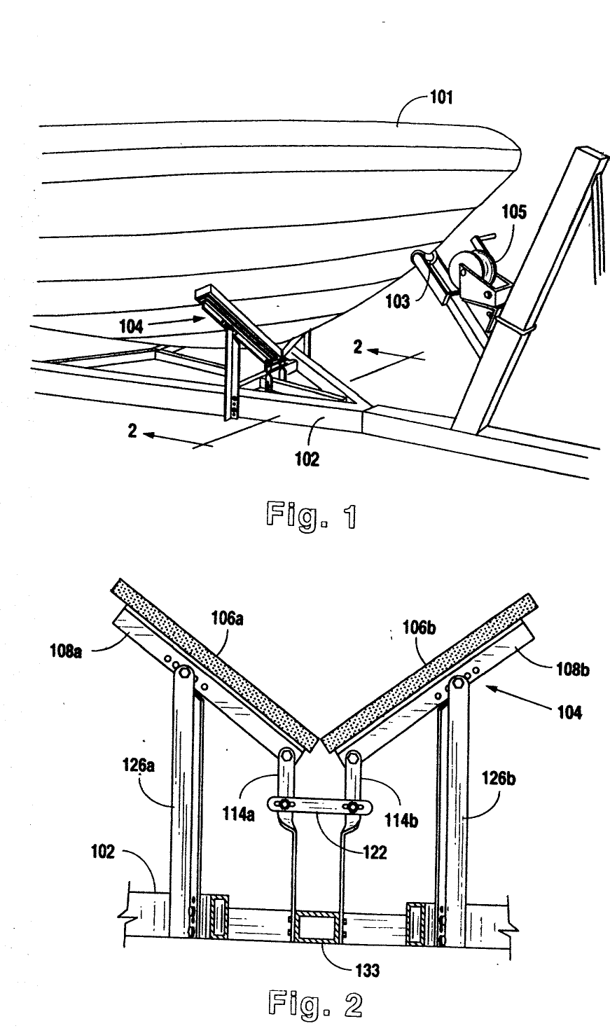

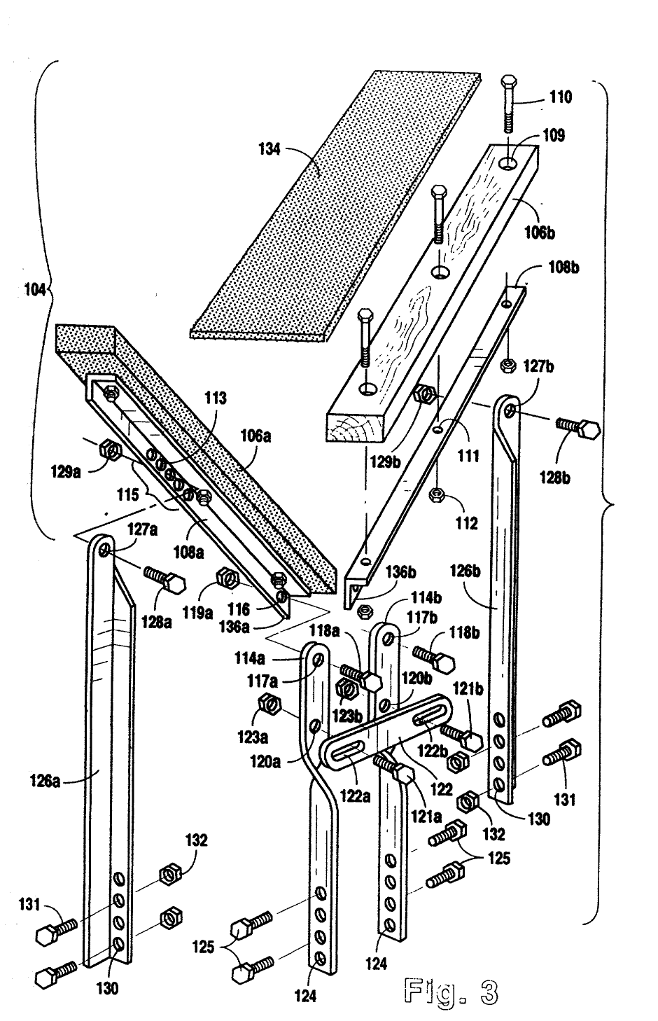

### CROSS-REFERENCE TO PRIOR APPLICATION

Priority is claimed based on a previously filed provisional application with serial number:______

### BACKGROUND OF THE INVENTION

U.S. Pat. No. 6,034,639, and the references cited therein, all incorporated by reference, show several portable communicators with retractable antennas. The references and the state of the art disclose materials and techniques that are adaptable by those having ordinary skill for providing the present retractable earpiece and mouthpiece, in addition to retractable antennas.

### SUMMARY OF THE INVENTION

If a thin wire material or other attractive material is used for the support stalks, an attractive design appearance is obtained. Curved and/or flexible support stalks can place the earpiece and mouthpiece accurately where they are needed and can improve the overall fit on the user's head.

Strength and/or stiffness can be enhanced by covering a wire material with a stiff plastic or other material.

In addition, by making the support stalks for the mouthpiece and earpiece of an appropriate material, for example a conductive material, either or both of the support stalks can be used to form an antenna (quarter-wave, half-wave, or another type) for the portable communicator. Further, if one of the support stalks is used as an antenna, the other support stalk can be used as an antenna counterpoise for the communicator. Those skilled in the art will appreciate the conventional relationships between length and frequency for such an antenna and/or counterpoise. Further, those skilled in the art will appreciate ways in which additional capacitance and/or inductance or other modifications can be added to such antenna and/or counterpoise to set a desired resonant frequency.

### DESCRIPTION OF THE DRAWING

FIG. (a) shows a portable communicator such as a cellular telephone which can be made extremely compact, for example the size of the user's ear, by having both a retractable earpiece containing an earphone, and a retractable mouthpiece containing a microphone.

FIG. (b) shows a second embodiment of the invention in which the mouthpiece is automatically retracted in response to manually retracting the earpiece. The end of the earpiece stalk inside the case is attached to a wire, chain or other strong, flexible linkage. The other end of the chain is attached to the inside end of the mouthpiece stalk. Pushing the earpiece stalk into the case draws the chain over a pulley at the upper end of the case, thereby drawing the mouthpiece stalk into the case as well.

In the embodiment of FIG. (c), a spring is provided to force out the earpiece stalk. The earpiece stalk is held in the case by any appropriate catch or latch (not shown)while the spring stores mechanical energy inside the case. The spring can store mechanical energy by being either stretched or compressed. Skilled persons will appreciate appropriate ways of mounting either a compression spring or a tension spring for this purpose.

When the earpiece is ejected by the spring, the chain is loosened, permitting the mouthpiece to be pulled out manually. If the chain or linkage is provided with sufficient stiffness, the movement of the linkage in response to ejection of the earpiece can be utilized to automatically eject the mouthpiece as well.

Alternatively, both the mouthpiece and earpiece can be spring-loaded, and an appropriate catch or catches can be provided to release both the mouthpiece and earpiece simultaneously. In addition, the above-described chain or linkage can be included so that one of the stalks automatically retracts in response to manual retraction of the other.

Further, in the spring-loaded embodiments just described, a solenoid or other electromechanical device can be provided to automatically release the catch or catches and eject one or both stalks in response to an incoming communication, for example after a given number of ring signals from a ringer circuit:

All of the specific features mentioned above can be freely selected, rearranged and recombined to form additional embodiments of the invention. In addition, the respective features of the earpiece and mouthpiece can be interchanged at will.

Although the present invention has been described in relation to particular embodiments thereof, many other variations and modifications and other uses will become apparent to those skilled in the art. The present invention is not limited by the specific disclosure herein.

What is claimed is:

1. A telephone device with at least one thin flexible extension rod having a second device at one end and connected to the telephone device at another end B, wherein said telephone device has means for retracting said at least one thin flexible extension rod.

2. A telephone device as in claim 1, wherein said second device is a speaker.

3. A telephone device as in claim 1, wherein said second device is a microphone.

4. A telephone device as in claim 1, further with circuitry to receive signals from said flexible extension rod, whereby said flexible extension rod acts as an antenna.
